(19) United States
(12) Patent Application Publication
(10) Pub. No.: US 2010/0291410 A1
(43) Pub. Date: Nov. 18, 2010

(54) Corrosion Protection and Lubrication of MEMS Devices

(75) Inventors: Vlad Novotny, Los Gatos, CA (US); Gabriel Matus, Santa Clara, CA (US)

Correspondence Address: FISH & RICHARDSON P.C., PO BOX 1022, MINNEAPOLIS, MN, 55440-1022, US

(73) Assignee: SPATIAL PHOTONICS, INC., Sunnyvale, CA (US)

(21) Appl. No.: 12/465,573

(22) Filed: May 13, 2009

(51) Int. Cl. B32B 9/00; B05D 5/12

(52) U.S. Cl. 428/702; 427/58

(57) ABSTRACT

Systems and methods, such as for a MEMS device, can include a component having a contact portion that includes on one side a layer including hydrophilic functional groups and a coating formed on the layer. The coating can include hydrophilic functional groups adapted to interact with the hydrophilic functional groups of the layer. The coating can also include hydrophobic functional groups opposite the hydrophilic functional groups of the coating. The layer can be bonded to the component, and the coating can be bonded to the layer. The coating can be adapted to be formed on the layer while in vapor form and can include a lubricant. The layer can be an atomic monolayer or multilayer, such as of aluminum oxide, and the coating can include a fluorinated acid, such as perfluorodecanoic acid.

### BACKGROUND

This description relates to mechanical systems, such as Micro-Electro-Mechanical Systems (MEMS).

One type of MEMS is a Spatial Light Modulators (SLMs) device that operates by tilting individual micro-mirror plates around a torsion hinge with an electrostatic torque to deflect incident light in a direction that depends on the orientation of the micro-mirror plates. In digital mode operation, each individual micro-mirror plate acts as a pixel that can be turned “on” or “off” by selectively rotating the individual mirror. The mirrors can be mechanically stopped at a specific landing position to ensure the precise deflection angles. A functional micro-mirror array requires sufficient electrostatic torque and mechanical restoring torque to overcome contact static torque or “stiction” at the mechanical stops and to control timing and ensure reliability. A SLMs device may be used, for example, for displaying video images.

### SUMMARY

In MEMS devices, actuators and sensors can be formed from electrically conductive materials. Electrical current flows, such as through actuators and sensors, can cause or contribute to degradation of a MEMS device as a result of corrosion by electrochemical oxidation and reduction. Also, adhesion between contact surfaces in a MEMS device can cause or contribute to sticking or otherwise limit operation of the MEMS device. A MEMS device can be implemented with, for example, an atomic or molecular layer or multilayers formed on surfaces thereof. A coating can be applied to the layer or multilayer. The coating can be used without activation or with activations that release a lubricant. The layer and the coating can interact with the remainder of the MEMS device to mitigate or prevent corrosion or adhesion or both.

In a general aspect, the present disclosure relates to systems and methods including a first component having a contact portion that includes on one side a layer including hydrophilic functional groups and a coating formed on the layer. The coating can include hydrophilic functional groups adapted to interact with the hydrophilic functional groups of the layer. The coating can also include hydrophobic functional groups opposite the hydrophilic functional groups of the coating.

In another aspect, the present disclosure relates to systems and methods including forming a mechanical device having a first contact potion, forming a layer on the side of the first contact portion, and applying a coating to the layer. The layer can include hydrophilic functional groups, and the coating can include hydrophilic functional groups adapted to bond to the hydrophilic functional groups of the layer. The coating can also include hydrophilic functional groups opposite the hydrophilic functional groups of the coating.

Implementations may include one or more of the following. The layer can be chemically bonded to the contact portion of the first component. The layer can be an atomic monolayer, can be a multilayer, and can include an oxide or nitride, such as aluminum oxide. The coating can include a carboxylic acid functional group and can include a fluorinated acid, such as perfluorodecanoic acid. Hydrophilic functional groups of the coating can be bonded to hydrophilic functional groups of the layer, such as relatively weakly bonded. The coating can be adapted to be formed on the layer while in a vapor form and can be adapted to bond to the layer when exposed to an elevated temperature. The coating can be adapted to release a lubricant when exposed to an elevated temperature. The mechanical device can be a MEMS device and can be a spatial light modulator. The layer can cover substantially all of the mechanical device and the coating can cover substantially all of the layer. The coating can be adapted such that, upon activation of the coating, hydrophilic functional groups of the coating bond to hydrophilic functional groups of the layer, and the coating can be relatively weakly bonded to the layer. Activating the coating can include releasing a lubricant encapsulated in the coating. A second component can include a contact portion in removable contact with the one side of the contact portion of the first component.

Forming the layer can include chemically bonding the layer to a surface of the mechanical device. Systems and methods can include activating the coating such that hydrophilic functional groups of the coating bond to hydrophilic functional groups of the layer. Activating the coating can include exposing the coating to an elevated temperature. Systems and methods can also include forming a second contact portion, the second contact portion being proximate a side of the first contact portion and configured to removably contact the first contact portion.

Implementations can provide none, some, or all of the following advantages. A monolayer or multilayer, such as inorganic, dielectric layers, can improve corrosion resistance, such as by reducing or eliminating anodic oxidation. Use of such an inorganic multilayer and an organic lubricating coating can provide improved corrosion resistance as compared to either an inorganic layer alone or a lubricating coating alone. Presence of a coating in conjunction with an inorganic layer can repel water and other organic adsorbates, thereby further mitigating anodic oxidation or other corrosion. The organic monolayer or multilayer can provide wear resistance, thereby increasing useful life of the SLM unit. In some implementations, weak bonding between the coating and the dielectric layer can facilitate surface mobility that can enable the coating to cover portions of the layer from which the coating has been removed by wear or damage. Such surface mobility can also further improve corrosion and wear resistance of the SLM unit. The use of an inorganic layer and a coating can reduce stiction and thereby reduce the voltages necessary for reliable operation of the SLM unit. Low adhesion force and low adhesion moments between movable and stationary components of the SLM unit can be achieved. Static friction can be minimized and sticking of components can be reduced or prevented. Further, use of a layer and a coating can minimize or prevent an increase in adhesion forces during a device operational lifetime.

### BRIEF DESCRIPTION OF DRAWINGS

FIG. 1a is a cross-sectional schematic of a portion of a spatial light modulator deflecting light to an “on” state.

FIG. 1b is a cross-sectional schematic of the spatial light modulator of FIG. 1a deflecting light to an “off” state.

FIG. 2 is a perspective-view schematic of a portion of an array of rectangular shaped mirrors of a projection system.

FIG. 3 is a perspective-view schematic of a lower portion of a spatial light modulator.

FIG. 4 is a cross-sectional schematic of a portion of the spatial light modulator of FIG. 1la.

FIG. 5 is a schematic representation of a coating and a chemical structure of a layer.

FIG. 6 is a flow chart representing a process for coating an SLM unit.

Like reference symbols in the various drawings indicate like elements.

### DETAILED DESCRIPTION

Micro-electro-mechanical actuators and sensors are typically formed from electrically conductive materials. When voltages are applied to actuators or when sensors generate electrical signals, the electrical current flows in these systems and devices can undergo degradation as a result of electrochemical oxidation and reduction, which may be referred to as corrosion. In addition, when MEMS surfaces mechanically contact one another, adhesion forces between surfaces can become higher than electrically generated restoring forces and mechanical restoring forces. The adhesion forces can prevent these surfaces from separating, which can prevent desired operation of the MEMS. This disclosure addresses limiting corrosion and reducing stiction. A MEMS device can be implemented with, for example, an atomic or molecular layer or multilayers formed on surfaces thereof. A coating can be applied to the layer or multilayer. The coating can be used without activation or with activations that release a lubricant. The layer and the coating can be configured to minimize or reduce corrosion or adhesion or both.

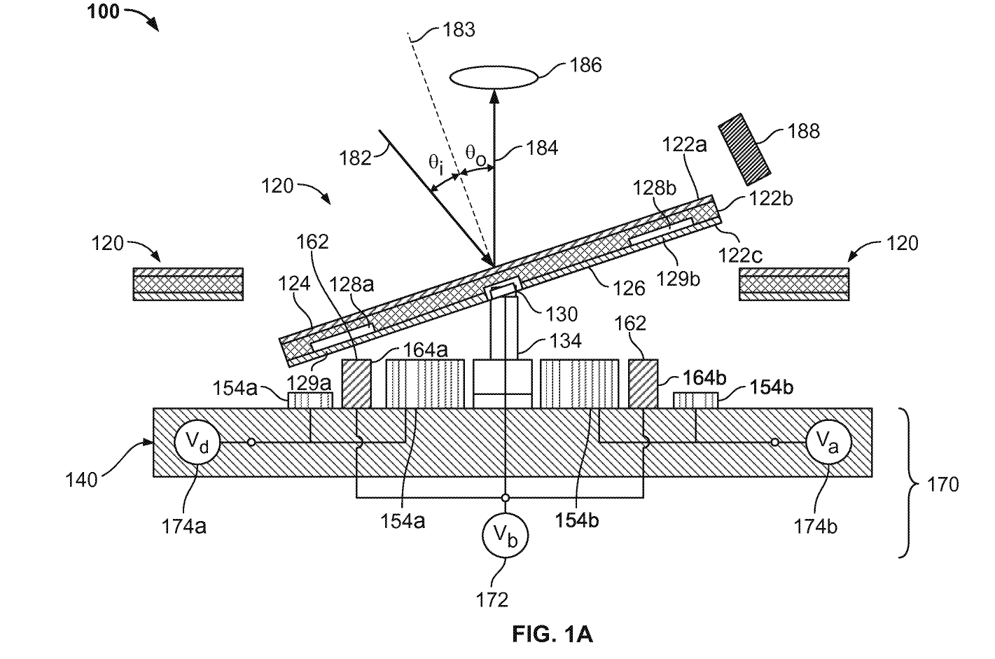

FIG. 1a is a cross-sectional schematic of a portion of a SLMs unit 100 (also referred to herein as a “SLM unit”) deflecting light to an “on” state. An SLM device can include multiple SLM units 100 similar to the one depicted in FIG. 1a. Examples of SLMs devices include those described in U.S. Pat. No. 7,443,572 to Pan et al., the entirety of which is hereby incorporated herein by reference. A mirror plate 120 is tilted on a hinge 130 toward electrodes 154a. Illumination light 182 from an illumination source (not shown) forms an angle of incidence θᵢ relative to a direction 183 normal to the reflecting surface. Reflected light 184 has an angle of θₒ, as measured in a direction normal to a top surface 124 of the mirror plate 120, and can exit the SLM unit 100 toward a target 186, such as a lens (not shown) or other display component. The angles θᵢ and θₒ are equal to one another. In a digital operation mode, the configuration shown in FIG. 1 a can be referred to as an “on” state or “on” position for purposes of this disclosure.

FIG. 1b is a cross-sectional schematic of the SLM unit 100 of FIG. 1a reflecting light to an “off” state. The mirror plate 120 is tilted toward an electrode 154a. The illumination light 182 and deflected light 184 form angles θᵢ∝0 and θₒ′ when the SLM unit is in the “off” position. These angles can be a function of the dimensions of mirror plate 120 and a gap between the bottom surface 126 of mirror plate 120 and the top surfaces 162 of landing posts 164a, 164b, described further herein, or other structure. The reflected light 184 exits the SLM unit 100 toward a light absorber 188. In a digital operation mode, the configuration shown in FIG. 1b can be referred to as an “off” state or “off” position for purposes of this disclosure.

The SLM unit 100 can be viewed as including a bottom portion, a middle portion, and an upper portion. The bottom portion of the SLM unit 100 can include a wafer substrate 140 and addressing circuitry 170 to selectively control operation of each mirror plate 120 in a micro-mirror array of an SLM device. The addressing circuitry 170 can include an array of memory cells and word-line/bit-line interconnects for communicating signals. The wafer substrate 140 can be a silicon substrate and can be fabricated using conventional complementary metal-oxide-semiconductor (CMOS) techniques. The addressing circuitry 170 can be fabricated to resemble a low-density memory array. Voltage source Vb 172 can control a voltage potential of the mirror plate 120 and the landing posts 164a, 164b. Voltage source Vd 174a can control a voltage potential of electrodes 154a. Voltage source Va 174b can control a voltage potential of electrodes 154b.

The middle portion of the SLM unit 100 can be formed on the substrate 140. The middle portion can include electrodes 154a, 154b and a hinge support post 134. Optionally, the middle portion can include a first landing post 164a and a second landing post 164b, The landing posts 164a, 164b can be stationary and vertical and can be formed on the substrate 140. For ease of manufacturing, the landing posts 164a, 164b can have a same height as the highest top surface of the electrodes 154a, 154b. The landing posts 164a, 164b can facilitate a mechanical touchdown for the mirror plate 120 to land on for each transition from an “on” state to an “off” state and from an “off” state to an “on” state. Optionally, bridge springs 129a, 129b, described further herein, can also be formed with or attached to the mirror plate 120 and can be touchdown regions of the mirror plate 120. The bridge springs 129a, 129b together with landing posts 164a, 164b may thereby help minimize or overcome stiction and prolong the reliability of the device. Stiction can include a force required to cause relative movement between the mirror plate 120 and other components of the SLM unit 100. Stiction can be, for example, an adhesion moment or an adhesion force and can be associated with the hinge 130, contact between the mirror plate 120 and other components, both, or other sources of friction or adhesion. In some implementations, the landing posts 164a, 164b can be electrically connected to the mirror plate 120. Such electrical connection can reduce or eliminate electrical arcing that might otherwise occur between the mirror plate 120 and the landing posts 164a, 164b during operation of the SLM unit 100.

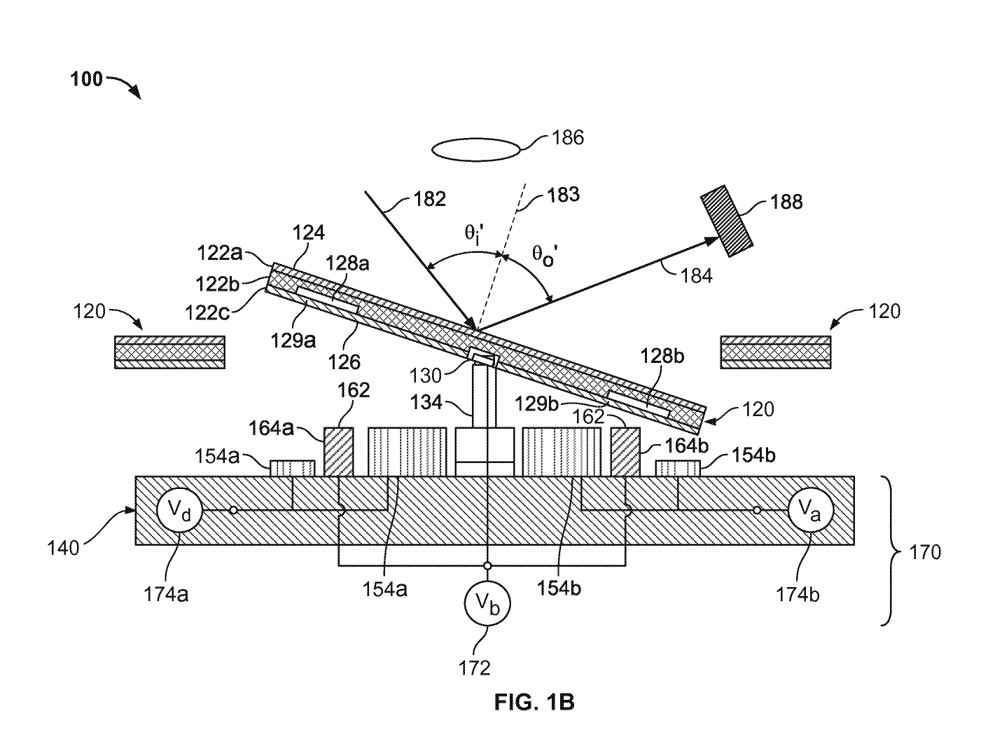

The upper portion of the SLM unit 100 can include the mirror plate 120. Torsion hinges 130 can be fabricated as part of the mirror plate 120 and can be kept a minimum distance from the top surface 124 of the mirror plate 120. The torsion hinges 130 can be configured to allow the mirror plate to rotate about a mirror axis 220 (see FIG. 2). By minimizing a distance between the mirror axis 220 and the top surface 124 of the mirror plate 120, horizontal displacement of each mirror plate 120 during an angular transition from “on” state to “off” state can be minimized. In the implementation shown in FIGS. 1a and 1b, the mirror plate 120 includes three thin film layers 122a, 122b, 122c. Each of the thin film layers 122a, 122b, 122c can have a material composition that is different from an adjacent layer. In some implementations, a top layer 122a is reflective and includes a reflective material, such as aluminum, and can be, for example, between about 50 and 100 nanometers (nm) thick, such as about 60 nm thick.

A middle layer 122b of the mirror plate 120 can be composed of one or more of many electrically conductive materials such as doped silicon, low temperature amorphous silicon, metal, or metal alloy. The middle layer 122b can be between, for example, about 100 to 500 nm thick, such as between about 100 and 200 nm. Alternatively, the middle layer 122b can include another low temperature deposited material, such as a material that is deposited by physical vapor deposition (PVD) or sputtering, including one or more of, for example, doped silicon, amorphous silicon, nickel, titanium, tantalum, tungsten, or molybdenum. In some implementations, the middle layer 122b can include a composite layer of more than one material, such as more than one metal. Cavities 128a, 128b can be formed in the middle layer 122b so to form bridge springs 129a, 129b in the bottom layer 122c, and the bridge springs 129a, 129b can be positioned to align with the landing posts 164a, 164b.

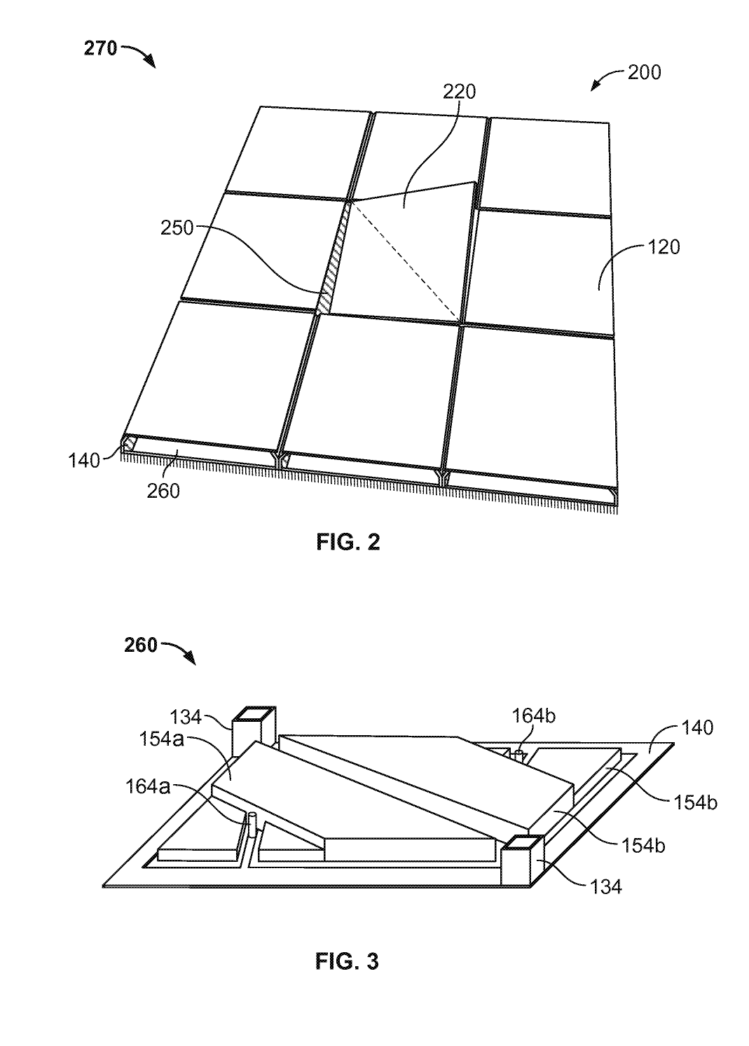

A bottom layer 122c of the mirror plate 120 can include an electrically conductive material, such as metal thin films based electromechanical materials, such as titanium, tantalum, tungsten, molybdenum, nickel, their silicides, and their alloys. A suitable titanium alloy can include aluminum, nickel, copper, oxygen and/or nitrogen. Another suitable material for the bottom layer 122c can be highly doped conductive amorphous silicon. The bottom layer 122c can be between about 10 to 100 nm thick, such as between about 50 to 60 nm thick. The hinge 130 can be implemented as part of the bottom layer 122c. Bridge springs 129a, 129b that are formed by portions of the bottom layer 122c exposed to the cavities 128a, 128b can be configured to deflect into the cavities 128a, 128b when the bottom layer 122c contacts the landing posts 164a, 164b. Portions of the bottom layer 122c exposed to the cavities 128a, 128b can thereby function as a spring and may be referred to as springs herein. Force exerted by these portions of the bottom layer 122c can facilitate removal of the mirror plate 120 from contact and switching between the “on” state and the “off” state. In some implementations, the bottom layer 122c of the mirror plate 120 and the torsion hinges 130 consist of one of the refractory metals, their silicides or their alloys. Refractory metals and their silicides can be compatible with CMOS semiconductor processing and can have relatively good mechanical properties. These materials can be deposited by Physical Vapor Deposition (PVD), Chemical Vapor Deposition (CVD), Plasma Enhanced CVD (PECVD), or other suitable techniques. The three layer thin film mirror plate 120 can have a total thickness of, for example, between about 100 nm and about 5000 nm, such as between about 200 and 300 nm. FIG. 2 is a perspective-view schematic of a portion of an SLM array 200 of SLM units 100 having rectangular-shaped mirror plates 120. FIG. 3 is a perspective-view schematic of a lower portion of an SLM unit 100. Referring to FIGS. 2 and 3, the mirror plates 120 can be supported by torsion hinges 130 such that the mirror plates 120 can rotate about mirror axis 220. A gap 250 between adjacent mirror plates 120 in an array 200 of SLM units 100 as part of an SLM device can be relatively small. For example, the gap 250 between mirror plates 120 in the SLM array 200 can be reduced to, for example, less than 0.5 microns. Minimizing the gap 250 can be desirable in some implementations to achieve a high active reflection area fill-ratio. That is, as the gap 250 decreases, a higher percentage of illumination light 182 can be reflected by the mirror plates 120 as deflected light 184. Space between the substrate 140 and the mirror plates 120 can be referred to as a lower space 260. In FIG. 3, an SLM unit 100 is shown for illustrative purposes without a mirror plate 120, and the lower space 260 is thus shown. In some implementations, lower spaces 260 are exposed to a surrounding environment 270 only through the gaps 250.

The SLM unit 100 and the SLM array 200 can be fabricated as described in U.S. Pat. No. 7,388,708 to Pan, which is incorporated by reference herein in its entirety. Materials used in constructing a micro-mirror array are preferably processed at a temperature below about 400 to 450 degrees Celsius, a typical manufacturing process temperature limitation to avoid damaging the pre-fabricated circuitries in the control substrate. In some implementations, processing of the SLM unit 100 can be at a temperature below about 150 degrees Celsius.

As mentioned above, stiction of a mirror plate 120 in the “on” state or the “off” state can occur during operation of an SLM unit 100. In some instances the surface contact adhesion can be greater than a sum of the electrostatic forces exerted by the electrostatic fields generated between the electrodes 154a, 154b and the mirror plate 120, as well as mechanical restoring forces. In such instances, the sticking mirror of the SLM unit 100 may cease to operate, potentially requiring replacement of an entire SLM array 200 or an entire SLM device. Surface contact adhesion may be caused by dipole-dipole interactions and additionally by water or outgassing organic materials present between the mirror plate 120 with bridge springs 129a, 129b and the landing posts 164a, 164b, which may cause device failure from stiction in such environments. To reduce contact adhesion between the bottom layer 122c and the landing posts 164a, 164b, and to protect mechanical wear of interfaces during operation, a lubricant can be deposited on the bottom surface 126 of mirror plate 120 and on the top surfaces 162 of the landing posts 164a, 164b. It can be desirable in some implementations that the lubricant is thermally stable, has finite vapor pressure, and is non-reactive with electromechanical materials that form the SLM unit 100. In other implementations, it may be desirable to attach lubricant to electrochemical materials that come into mechanical contact with one another. In some implementations, the lubricant can be applied to substantially all exposed surfaces of the SLM unit 100.

In some implementations, the lubricant can be a fluorocarbon thin film coated on the bottom surface 126 of the mirror plate 120 and on the top surfaces 162 of the landing posts 164a, 164b. For example, an SLM unit 100 can be exposed to fluorocarbons, such as CF₄, at a substrate temperature of about 200 degrees Celsius. In another example, the lubricant can be composed of long chain fluorocarbon molecules which are vaporized to form a gas, which may then condense onto the SLM. The resulting fluorocarbon coating can prevent or reduce adherence or attachment of water to the interfaces of the bottom layer 122c and the landing posts 164a, 164b, which can reduce stiction of the bottom layer 122c in a moist or humid surrounding environment 270. Applying a fluorocarbon film to contact portions of the bottom layer 120 and the landing posts 164a, 164b can reduce adhesion forces by reduction of dipole-dipole interactions and also prevent adsorption of organic contaminants and furthermore minimize an amount of water on contact surfaces, which may thereby reduce stiction.

Corrosion of bridge springs 129a, 129b, torsion springs, reflective surfaces, such as top layer 122a, landing posts 164a, 164b, and of electrical connections thereto can also occur during operation of an SLM unit 100. Such corrosion can result from flow of electrical current to or from components of the SLM unit 100 and may include corrosion of a component that constitutes an anode or cathode of an electric circuit. It can therefore be desirable to insulate the landing posts 164a, 164b and other components of the SLM unit 100, such as the mirror plate 120 and electrical connections to the landing posts 164a, 164b. Insulating can be done using a dielectric material. By lessening or preventing flows of electrical current, a dielectric or some other suitable material can mitigate or prevent oxidation or other corrosion. Alternatively, surfaces that are prone to corrosion can be covered with materials that do not corrode and that protect corroding materials from exposure to water and oxygen.

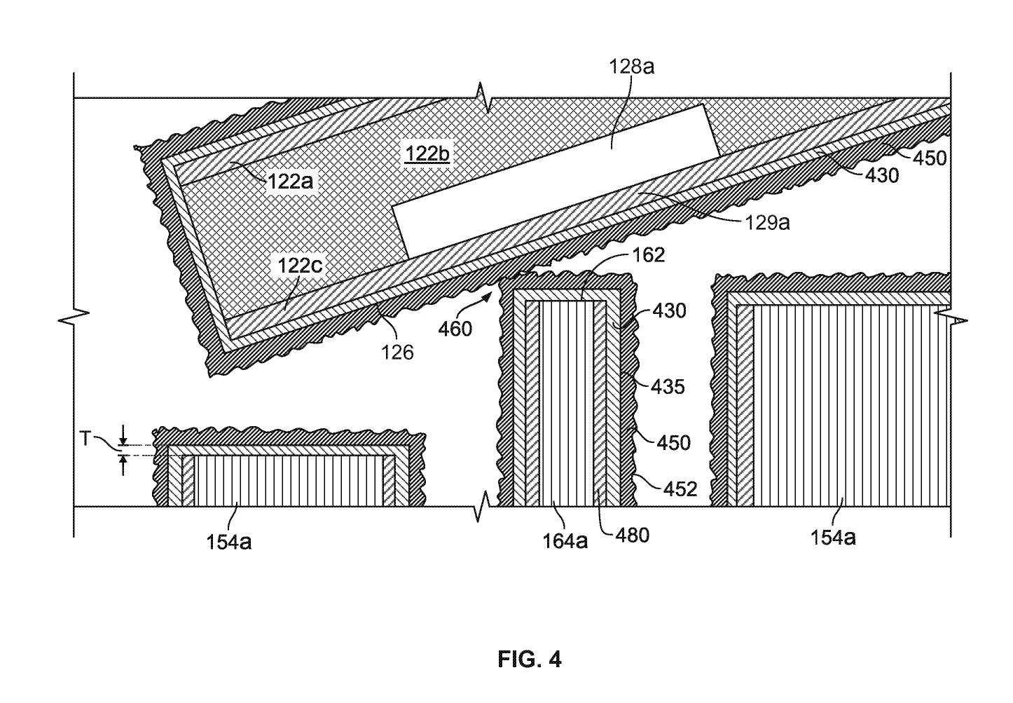

FIG. 4 is a cross-sectional schematic of a portion of the SLM unit 100, and a layer 430 is shown formed thereon. For illustrative purposes, FIG. 4 has not necessarily been drawn to scale. In some implementations, the layer 430 can be inorganic and dielectric. The layer 430 can be formed on some or all surfaces of the SLM unit 100, such as on the top surface 162 of the landing post 164a and on the surface of the bottom layer 122c including on the bridge spring 129a, which can be a portion of the bottom layer 122c over the cavity 128a. The layer 430 can be conformally formed on surfaces of the SLM unit 100 using atomic layer deposition (ALD) techniques, and the layer 430 can have a thickness T. The thickness T can be uniform across substantially all exposed surfaces of the SLM unit 100. In some implementations, the layer 430 can include between 5 and 15 atomic monolayers. Formation of the layer 430 by ALD can be advantageous because it can be desirable to completely cover exposed surfaces of the SLM unit 100, such as exposed surfaces of the landing posts 164a, 164b and bridge springs 129a, 129b. For example, complete coverage can mitigate or prevent anodic oxidation by lessening or preventing current flow to or from the landing posts 164a, 164b or other components of the SLM unit 100. That is, the presence of “pinholes,” voids, or otherwise incomplete coverage of components of the SLM unit 100 can significantly compromise the corrosion prevention performance of the layer 430 because electric current may flow through such pinholes, voids, or other exposed surfaces.

A coating 450 can be applied to an exposed side 435 of the layer 430, and the coating 450 can be a monolayer or multilayer organic coating. For example, where a layer 430 is formed on the bottom surface 126 of the mirror plate 120, the coating 450 can be applied on a side of the layer 430 that is opposite the bottom surface 126. The coating 450 can lubricate a contact region 460 where the bottom surface 126 of the mirror plate 120 contacts the top surface 162 of the landing post 164a. In some implementations, an exposed side 452 of the coating 450 can be hydrophobic. This hydrophobic property of the coating 450 can reduce or eliminate the presence of water, moisture, and organic adsorbates on the lower space 460 surfaces or elsewhere in the SLM unit 100. Because moisture may be necessary for anodic oxidation to occur, use of a hydrophobic coating 450 can mitigate or prevent anodic oxidation. An operational lifetime of the SLM unit 100 may thereby be extended as compared to a unit that lacks the layer 430 and the coating 450.

The layer 430 can include a material adapted for holding the coating 450. For example, the layer 430 can include a material that increases attractive forces between atoms or molecules of layer 430 and the coating 450. The coating 450 can be chemically bonded to the layer 430, and such chemical bonding can occur after activation of the coating 450, as discussed below. In some implementations, the coating 450 can be relatively strongly bonded to the layer 430. In some other implementations, the coating 450 can be relatively weakly bonded to the layer 430. Relatively weak bonding of the coating 450 can permit surface mobility of the coating 450. That is, where the coating 450 is relatively weakly bonded to the layer 430, molecules of the coating 450 can move from one location on the layer 430 to another. This movement of molecules of the coating 450 can facilitate “self-repair” of wear or damage to the coating 450. That is, if a portion of the coating 450 is removed by wear or damage, molecules of the coating 450 nearby or adjacent to that portion can move to fill in the coating 450 and thereby facilitate complete coverage of the layer 430. In other cases, the finite vapor pressure of the lubricant or anti-stiction coating in the cavity can repair the damage in the coating 450 by adsorption of the coating molecules. In such a case, surface mobility of the coating 450 may not be required.

Optionally, the SLM unit 100 can include a spacer 480 formed on the electrodes 154a, 154b and landing posts 164a, 164b. The spacer 480 can be formed as a blanket layer 100 nm thick of PECVD silicon dioxide. After formation, the spacer 480 can be blanket etched with a directional plasma etch to expose the top of the electrodes 154a, 154b, leaving the spacer 480 on the sides of the electrodes 154a, 154b and landing posts 164a, 164b. Film thickness of the spacer 480 after etching can vary from 100 nm at the substrate 140 to zero thickness at the top of the electrodes 154a, 154b and landing posts 164a, 164b. In some implementations, the spacer 480 can minimize or prevent static electrical shorts between the electrodes 154a, 154b and other components.

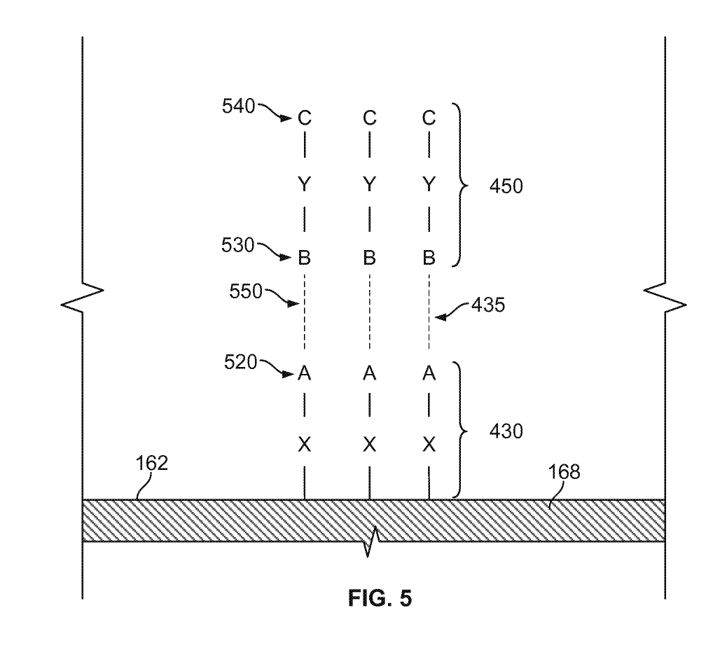

FIG. 5 is a schematic representation of chemical structures of a layer 430 formed on the top surface 162 of the landing post 164a and a coating 450 bonded or adsorbed to the layer 430 and the same layers on bridge spring 129a. The layer 430 can include a hydrophilic functional group 520 on the exposed side 435 of the layer 430. Hydrophilic functional groups 520 of the layer 430 are represented by letter “A” in FIG. 5. The exposed side 435 can be on a side of the layer 430 that is opposite a component on which the layer 430 is formed. The layer 430 can include any material having hydrophilic functional groups 520. In some implementations, the layer 430 can include an oxide. The oxide can be, for example, aluminum oxide, silicon oxide, titanium oxide, zirconium oxide, or other oxide. The layer 430 can be composed of multiple molecules having hydrophilic functional groups 520.

Thickness T (see FIG. 4) of the layer 430 in some implementations can be small, such as about fifteen monolayers or less, such as between about five and fifteen atomic monolayers. Some implementations can include a layer 430 with a thickness T of less than five monolayers, such as one atomic monolayer. In implementations where the layer 430 is composed of aluminum oxide, the thickness T of the layer 430 can be less than about 2.0 nm, and in other cases less than about 1.0 nm. In some implementations, the layer 430 can be less than about 0.2 nm. A small thickness T of the layer 430 may be desirable in implementations where the layer 430 covers the electrodes 154a, 154b. Voltage applied between the mirror plate 120 and the electrodes 154a, 154b provides actuating force for switching the mirror plate 120 between the “on” state and the “off” state. Presence of the layer 430 on the electrodes 154a, 154b may decrease electrostatic forces applied to the mirror plate 120 relative to electrostatic forces that would be applied without presence of the layer 430 on the electrodes 154a, 154b. Increased thickness T of the layer 430 may result in further decreased electrostatic forces. Thus, increasing the thickness T of the layer 430 can result in a need for greater applied voltage between the mirror plate 120 and the electrodes 154a, 154b for actuation of the mirror plate 120. It can therefore be desirable to minimize the thickness T of the layer 430 but keep the thickness T that adequately minimizes corrosion.

Many material deposition techniques, such as sputtering or chemical vapor deposition, do not reliably provide complete, contiguous coverage of a surface by a relatively thin layer, in particular surfaces that are not in direct “line of sight”. Instead, with such techniques, a relatively thick layer must typically be deposited to ensure complete coverage having no pin-holes or voids. In addition, some material deposition techniques, such as sputtering, provide deposition only on a “line-of-sight” basis. That is, obstructions between a surface and the material deposition source may prevent material from being deposited on that surface. ALD techniques can utilize precursors in gaseous or vapor form that can reach surfaces that might be obstructed or otherwise not in line-of-sight for other material deposition techniques. ALD techniques are further described in Dennis M. Hausmann et al., “Atomic Layer Deposition of Hafnium and Zirconium Oxides Using Metal Amide Precursors” Chem. Mater. 14 (2002) 4350-4358. ALD techniques can facilitate formation of a complete, conformal, contiguous layer 430 and can therefore facilitate use of a relatively thin layer 430.

An ALD process can include exposing a surface in a reaction chamber to a first precursor. The first precursor can uniformly and conformally form a precursor layer on the surface. The reaction chamber can then be evacuated to remove first precursor molecules that have not reacted with or bonded to the surface. A second precursor can then be introduced into the reaction chamber. The second precursor can react with the first precursor to form a uniform, conformal monolayer on the surface. The reaction of the second precursor and the first precursor can be self-limiting such that only one atomic layer is bonded to the surface. One ALD cycle can thus include introducing the first precursor to the reaction chamber, evacuating the chamber, introducing the second precursor to the reaction chamber, and again evacuating the chamber. The ALD cycle can be repeated to form additional monolayers on previously formed monolayers. That is, in each additional ALD cycle, an additional monolayer can be formed on top of an exposed monolayer that was formed previously.

The coating 450 can include a hydrophilic functional group, B, 530 and can be physically or chemically bonded by bond 550 to a hydrophilic functional group 520 of the layer 430. The bond 550 can be a dipole-dipole bond, covalent bond, a hydrogen bond, or other suitable bond. The coating 450 can further include a hydrophobic functional group, C, 540 opposite the hydrophilic functional group 530 of the coating 450. Hydrophobic functional groups are represented by letter “C” in FIG. 5. The coating 450 can be composed of multiple molecules having hydrophilic functional groups 530 and hydrophobic functional groups 540. The coating 450 can include any material having both a hydrophilic functional group 530 and a hydrophobic functional group 540. In some implementations, the coating 450 can include a hydrophilic functional group 530, such as a carboxylic acid functional group, such as a carboxyl (COOH) functional group. The coating 450 can include a siloxane functional group, a phosphate functional group, a sulfate functional group or a silane functional group. Further, in some implementations, the coating 450 can include a hydrophobic functional group 540, such as a fluorinated compound, such as CF₃, and suitable materials can include perfluorooctanoic acid (PFOA), perfluorodecanoic acid (PFDA), fluoro-octyl-trichlorosilane (FOTS), some other fluorinated acid, or some suitable fluorinated compound. One such coating 450 can include PFDA manufactured by SynQuest Laboratories, Inc., of Alachua, Fla.

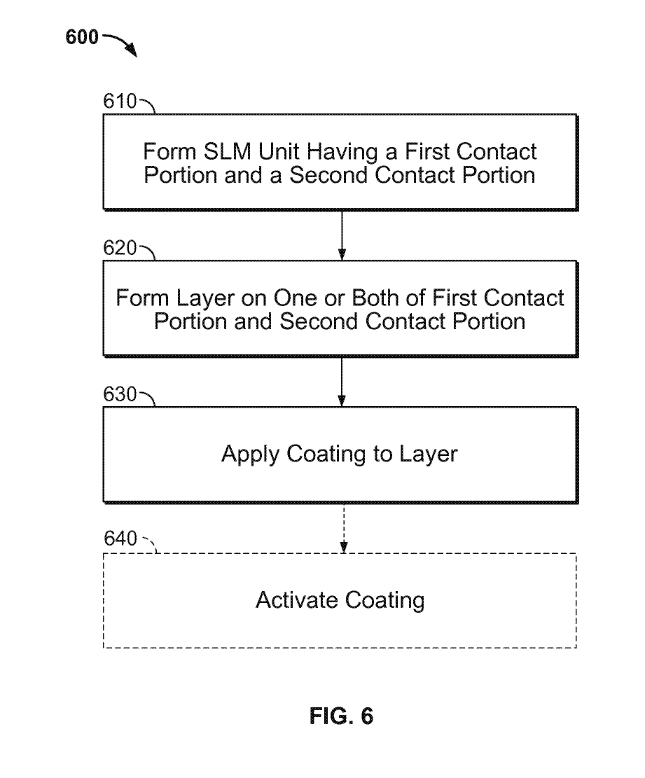

FIG. 6 is a flow chart representing a process 600 for coating an SLM unit 100. An SLM unit 100 as described above can be formed having a first contact portion and a second contact portion (step 610). The first contact portion can be, for example, the top surface 162 of one or both of the landing posts 164a, 164b. The second contact portion can be, for example, a portion of the bottom surface 126 of the bridge springs 129a, 129b. In some implementations, one or both of the first contact portion and the second contact portion can be surface treated. For example, the top surface 162 of the landing posts 164a, 164b and the bottom surface 126 of the bridge springs 129a, 129b can be coated with oxide or nitride. Such surface treatment may improve wear resistance of the SLM unit 100.

The layer 430 can be formed on the first contact portion (step 620). In some implementations, the layer 430 can be formed on the second contact portion instead of, or in addition to, being formed on the first contact portion. For ease of fabrication, the layer 430 can also be formed on substantially all surfaces of the SLM unit 100. Formation of the layer 430 during an ALD process can be conformal. That is, in some implementations, the layer 430 can be formed uniformly on all exposed surfaces of the SLM unit 100. This conformal formation of the layer 430 can be facilitated by ALD techniques that involve introducing precursor materials in gaseous or vapor form. Further, the ALD process can be self-limiting such that, for example, only a single monolayer is formed on the SLM unit 100 during each ALD cycle. A multilayer can be formed by performing multiple ALD cycles. Formation of the layer 430 on all or substantially all exposed surfaces of the SLM unit 100 may be desirable in some implementations to protect all or substantially all components of the SLM unit 100 from corrosion and stiction.

The coating 450 can be applied to the layer 430, for example, in the gaseous phase or in vapor form (step 630). The coating 450 can also be applied in nebulized form, such as described in United States Application Publication No. 2008/0062496 A1, filed by Seth Miller and published Mar. 13, 2008. However, a nebulized or atomized coating 450 material may be unable to adequately permeate the lower space 460 in some implementations due to, for example, small size of the gap 250 between mirror plates. Applying the coating 450 material in gaseous phase or in vapor form can facilitate complete coating of the layer 430. It can also be desirable in some implementations that the coating 450 is inactive, e.g., not bonded to the layer 430, upon application to the layer 430. For example, during wafer-level processing for manufacturing an SLM array 200, an active coating 450 may interfere with bonding of components of the SLM unit 100, or with other process steps. Bonding of other components of the SLM unit 100 may be performed despite a presence of unbonded or unactivated coating 450 material on the layer 430. For example, such coating 450 material may be displaced to facilitate bonding of other components. That is, such coating 450 material may be displaced from bond areas for other components of the SLM unit 100. As another example, coating 450 material might not interfere with adhesives used to bond other components of the SLM unit 100 while such coating 450 material is in an unbonded or unactivated state. In some implementations, the layer 430 can be thoroughly cleaned and protected from contamination in order to maximize particular properties, such as anti-stiction and anti-corrosion properties, of the coating 450. That is, excluding contamination from the coating can be important for effective application and bonding of the coating 450.

Optionally, the coating 450 can be activated, and the coating 450 can thereby bond to the layer 430 (step 640). In some implementations, the coating 450 is itself a lubricant, as the term lubricant has been described above, and activation of the coating 450 causes bonding of the coating to the layer 430.

In some implementations, such as when the coating 450 is deposited from the vapor phase, no activation is required. When the material of coating 450 is deposited in the liquid or solid form into a cavity of a device, activation by heating can release molecules of the coating into a volume of the cavity, which can facilitate coating of substantially all surfaces from vapor phase. A chemical bond between the surface functional groups of the coating 450 and layer 430 can be also formed by heating at elevated temperatures.

In some implementations, lubricant can include PFDA. The coating 450 can be activated by exposing the coating 450 to an elevated temperature or by some other suitable process. Elevated temperatures can be, for example, from about 50 degrees Celsius to about 250 degrees Celsius or higher. Bonding of the coating 450 can be self-limiting. That is, a layer of the coating 450 can be applied to the layer 430, after which the coating 450 material will not adhere to itself. Without being limited to any particular feature, this self-limiting feature can result from the use of a coating 450 material having a hydrophilic functional group at one end and a hydrophobic functional group at an opposite end. Hydrophilic functional groups 520 of the layer 430 can bond to hydrophilic functional groups 530 of the coating 450. Hydrophilic groups 530 of other coating 450 material may then be unable to bond to coating 450 material that has bonded to the layer 430. That is, the coating 450 material that has bonded to the layer 430 does not have unbonded hydrophilic groups available to bond to hydrophilic groups of other coating 450 material. In some implementations, the exposed hydrophobic groups 540 of the coating 450 cannot bond to hydrophobic groups of other coating 450 material strongly enough to add additional coating material to the coating 450. The above-described implementations can provide none, some, or all of the following advantages. A monolayer or multilayer, such as inorganic, dielectric layers, can improve corrosion resistance, such as by reducing or eliminating anodic oxidation. Use of such an inorganic multilayer and an organic lubricating coating can provide improved corrosion resistance as compared to either an inorganic layer alone or a lubricating coating alone. Presence of a coating in conjunction with an inorganic layer can repel water and other organic adsorbates, thereby further mitigating anodic oxidation or other corrosion. The organic monolayer or multilayer can provide wear resistance, thereby increasing useful life of the SLM unit. In some implementations, weak bonding between the coating and the dielectric layer can facilitate surface mobility that can enable the coating to cover portions of the layer from which the coating has been removed by wear or damage. Such surface mobility can also further improve corrosion and wear resistance of the SLM unit. The use of an inorganic layer and a coating can reduce stiction and thereby reduce the voltages necessary for reliable operation of the SLM unit. Low adhesion force and low adhesion moments between movable and stationary components of the SLM unit can be achieved. Static friction can be minimized and sticking of components can be reduced or prevented. Further, use of a layer and a coating can minimize or prevent an increase in adhesion forces during a device operational lifetime. In some implementations of an SLM unit, adhesion forces on the order of about 5 to 10 nanoNewtons (nN) or less can be achieved.

The use of terminology such as “top,” “bottom,” “upper,” and “lower” throughout the specification and claims is for illustrative purposes only, to distinguish between various components of the system and other elements described herein. The use of such terminology does not imply a particular orientation of any other components. Similarly, the use of any horizontal, vertical, or any other term describing orientation or angle of elements is in relation to the implementations described. In other implementations, the same or similar elements can be oriented other than horizontally, vertically, or at any other angle described, as the case may be.

A number of embodiments have been described. Nevertheless, it will be understood that various modifications may be made without departing from the spirit and scope of the invention. For example, the coating can be applied in a solid or liquid phase, such as in a powdered, nebulized, or atomized form. As another example, the layer and coating can be used in MEMS other than SLM devices, as well as in mechanical systems other than MEMS. Accordingly, other embodiments are within the scope of the following claims.

What is claimed is:

1. A mechanical device, comprising:
a first component having a contact portion that includes on one side a layer including hydrophilic functional groups; and
a coating formed on the layer, the coating including hydrophilic functional groups adapted to interact with the hydrophilic functional groups of the layer, and the coating including hydrophobic functional groups opposite the hydrophilic functional groups of the coating.

2. The device of claim 1, wherein the layer is chemically bonded to the contact portion of the first component.

3. The device of claim 1, wherein the layer is an atomic monolayer.

4. The device of claim 1, wherein the layer is a multilayer.

5. The device of claim 1, wherein the layer includes an oxide or nitride.

6. The device of claim 5, wherein the oxide is aluminum oxide.

7. The device of claim 1, wherein the coating includes a carboxylic acid functional group.

8. The device of claim 1, wherein the coating includes a fluorinated acid.

9. The device of claim 8, wherein the fluorinated acid is perfluorodecanoic acid.

10. The device of claim 1, wherein the hydrophilic functional groups of the coating are bonded to hydrophilic functional groups of the layer.

11. The device of claim 10, wherein the coating is relatively weakly bonded to the layer.

12. The device of claim 1, wherein the coating is adapted to be formed on the layer while in a vapor form.

13. The device of claim 1, wherein the coating is adapted to bond to the layer when exposed to an elevated temperature.

14. The device of claim 1, wherein the coating is adapted to release a lubricant when exposed to an elevated temperature.

15. The device of claim 1, wherein the mechanical device is a MEMS device.

16. The device of claim 1, wherein the mechanical device is a spatial light modulator.

17. The device of claim 1, wherein the layer covers substantially all of the mechanical device and wherein the coating covers substantially all of the layer.

18. The device of claim 1, wherein the coating is adapted such that, upon activation of the coating, hydrophilic functional groups of the coating bond to hydrophilic functional groups of the layer.

19. The device of claim 18, wherein activating the coating includes exposing the coating to an elevated temperature.

20. The device of claim 18, wherein the coating is relatively weakly bonded to the layer.

21. The device of claim 18, wherein activating the coating includes releasing a lubricant encapsulated in the coating.

22. The device of claim 1, further comprising:
a contact portion of a second component in removable contact with the one side of the contact portion of the first component.

23. A method of coating, comprising:
forming a mechanical device having a first contact portion;
forming a layer on the side of the first contact portion, the layer including hydrophilic functional groups; and
applying a coating to the layer including hydrophilic functional groups adapted to bond to the hydrophilic functional groups of the layer, the coating including hydrophobic functional groups opposite the hydrophilic functional groups of the coating.

24. The method of claim 23, wherein forming the layer includes chemically bonding the layer to a surface of the mechanical device.

25. The method of claim 23, wherein the layer includes an atomic monolayer.

26. The method of claim 23, wherein the layer includes an oxide.

27. The method of claim 26, wherein the oxide is aluminum oxide.

28. The method of claim 23, wherein the coating includes a carboxylic acid functional group.

29. The method of claim 23, wherein the coating includes a fluorinated acid.

30. The method of claim 29, wherein the acid is perfluorodecanoic acid.

31. The method of claim 23, wherein the mechanical device is a MEMS device.

32. The method of claim 23, wherein the layer covers substantially all of the mechanical device and wherein the coating covers substantially all of the layer.

33. The method of claim 23, further comprising:
activating the coating such that hydrophilic functional groups of the coating bond to hydrophilic functional groups of the layer.

34. The method of claim 33, wherein activating the coating includes exposing the coating to an elevated temperature.

35. The method of claim 33, wherein the coating is relatively weakly bonded to the layer.

36. The method of claim 33, wherein activating the coating includes releasing a lubricant encapsulated in the coating.

37. The method of claim 23, further comprising:
forming a second contact portion, the second contact portion being proximate a side of the first contact portion and configured to removably contact the first contact portion.
